(19) United States
(12) Patent Application Publication
(10) Pub. No.: US 2022/0003141 A1
(43) Pub. Date: Jan. 6, 2022

(54) REDUCING AGENT METERING MODULE WITH HEAT TRANSFER COATING

(71) Applicant: VITESCO TECHNOLOGIES GMBH, Hanover (DE)

(72) Inventor: Philippe MERTES, Toulouse (FR)

(21) Appl. No.: 17/294,224

(22) PCT Filed: Nov. 14, 2019
(86) PCT No.: PCT/EP2019/081318

§ 371 Date: May 14, 2021

(30) Foreign Application Priority Data
Nov. 15, 2018 (FR) 1860550

(51) Int. Cl. F01N 3/20; B01D 53/94; B29C 70/68

(52) U.S. Cl. CPC F01N 3/2066; B01D 53/9431; B29C 70/68; B29L 2031/30; F01N 2610/10; F01N 2610/1406; F01N 2610/02

(57) ABSTRACT

A module for metering a reducing agent intended for a vehicle selective catalytic reduction post-treatment, this module including: a body in which the reducing agent circulates, this body including a first compartment and a second compartment which are separated by a fluidtight partition; and a heating shell partially surrounding the body in the first compartment. The body includes a heat transfer coating made from a thermoplastic elastomer material having a thermal conductivity of at least 3 Watts per meter Kelvin, this heat transfer coating including: a first portion positioned between the heating shell and the body; a second portion partially surrounding the body in the second compartment; and thermal bridges passing through the fluidtight partition and connecting the first portion to the second portion.

### CROSS-REFERENCE TO RELATED APPLICATIONS

This application is the U.S. national phase of International Application No. PCT/EP2019/081318 filed Nov. 14, 2019 which designated the U.S. and claims priority to FR 1860550 filed Nov. 15, 2018, the entire contents of each of which are hereby incorporated by reference.

### BACKGROUND OF THE INVENTION

### Field of the Invention

The invention concerns the field of automotive engineering and relates to a module for metering a reducing agent intended for a Selective Catalytic Reduction (SCR) post-treatment for a vehicle.

### Description of the Related Art

Patent application US2008/0236147 describes a unit for distributing a reducing agent intended for selective catalytic reduction post-treatment for a vehicle. Such a unit, generally referred to as a “reducing agent injector” is mounted on a catalytic exhaust device in order to inject the reducing agent into same.

Selective catalytic reduction post-treatment has become unavoidable for certain vehicles given the changes to the legislation on reducing emissions, particularly nitrogen oxide (NOx) emissions. The reducing agent is generally a solution based on urea, such as AUS 32. The aforementioned patent application sets out the problems associated with extreme temperatures with regard to reducing agents. Specifically, AUS 32, for example, freezes at around −8° to −10°, whereas automotive specifications generally require the vehicle to operate down to −40°. There are various solutions already implemented for heating the reducing agents at the low temperatures and thus allowing the selective catalytic reduction post-treatment device to operate at temperatures below −8°. The aforementioned patent sets out solutions targeting the reducing agent injector.

A complete selective catalytic reduction post-treatment device comprises, in addition to the reducing agent injector, a reducing agent tank and a reducing agent metering module. The reducing agent tank stores the reducing agent and is periodically filled by the user. The metering module is generally connected to this tank by flexible pipes and comprises a pump so that the reducing agent can be distributed to the injector, likewise by a flexible pipes.

At the present time, developments in pollution-control legislation is tending not only to make selective catalytic reduction post-treatment unavoidable for certain vehicles, but is also demanding that this treatment be implemented in the very first seconds after the starting of the motor vehicle. Thus, when the exterior temperature is below the freezing point of the reducing agent and the vehicle is then started, the metering module needs to be capable of very quickly thawing the reducing agent it contains so that the post-treatment device can come into operation as early as possible. The heating solutions within the reducing agent metering module are generally supplemented by hoses, themselves heating, and by solutions for heating the injectors, such as the solutions described in the aforementioned patent application.

The devices of the prior art, and particularly the reducing agent metering modules, need to be continuously improved in order to maintain compliance with the changes in the legislation.

### SUMMARY OF THE INVENTION

The aim of the invention is to improve the reducing agent distribution modules of the prior art.

To this end, the invention relates to a module for metering a reducing agent intended for a vehicle selective catalytic reduction post-treatment, this module comprising:

a body in which the reducing agent circulates, this body comprising a first compartment and a second compartment which are separated by a fluidtight partition,
a heating shell partially surrounding the body in the first compartment.

The metering module according to the invention is characterized in that the body comprises a heat transfer coating made from a thermoplastic elastomer material having a thermal conductivity of at least 3 Watts per meter Kelvin, this heat transfer coating comprising:

a first portion positioned between the heating shell and the body;
a second portion partially surrounding the body in the second compartment;
thermal bridges passing through the fluidtight partition and connecting the first portion to the second portion.

Another subject-matter of the invention is a method for manufacturing a metering module as described hereinabove, and comprising the following steps:

molding as a single piece the module body having a partition delimiting a first and a second compartment, this partition comprising through-orifices between the first compartment and the second compartment;
overmolding onto the body a heat transfer coating of one piece in a thermoplastic elastomer material so that this coating fills the orifices of the fluidtight wall and at least partially surrounds the body in the first compartment and in the second compartment.

In such a metering module, the heating that allows the thawing of all of the reducing agent present in the module is more rapid than in a module of the prior art. The time taken for the post-treatment to come into operation is therefore shortened in the event of an engine start at a temperature at which the reducing agent is frozen.

The heat transfer coating performs a first function which is that of advantageously replacing the thermal compound that is generally placed between the body and the heating shell. In addition, the heat transfer coating performs an additional function which is that of itself conducting heat into the second compartment, and heating the reducing agent therein via the body, like the heating shell does in respect of the first compartment.

The invention thus applies specifically to metering modules comprising a first compartment in which the heating shell is situated, and a second compartment which does not have one. Specifically, a common design for these metering modules implements these two compartments within a body which comprises a fluidtight partition. This design is advantageous so far as speed, simplicity and cost of manufacture are concerned, while at the same time giving the modules thus produced a high level of reliability. This design uses a body made as a single piece and defining two cavities with a partition between them. One of these cavities houses the control electronics for the module and is closed by a cover, thus forming one of the compartments, which acts as a fluidtight casing for the electronics.

The invention applies to this type of module while improving the heating of the reducing agent within the module.

This progress in the speed at which the reducing agent is heated up can, incidentally, be converted fully or in part into a reduction in the thermal power needed for heating up the reducing agent.

The reducing agent metering module may also comprise the following additional features, alone or in combination:

the fluidtight partition comprises open-ended orifices which are filled by the thermal bridges;
the heat transfer coating is made as a single piece overmolded on the body;
the body is produced as a single piece;
the heating shell is in direct contact with the heat transfer coating;
the heating shell is fixed to the fluidtight partition and is clamped against the heat transfer coating;
the heat transfer coating has ribs on its external surface;
the first compartment of the body comprises electronic means and the heating shell is equipped with electrical heating elements connected to the electronic means;
the heating shall is equipped with circulation pipes for a hot fluid, and the second compartment of the body comprises electronic means.

### BRIEF DESCRIPTION OF THE DRAWINGS

Further features and advantages of the invention will become apparent from description there are given hereinafter by way of non-limiting and illustrative example, with reference to the accompanying drawings, in which:

FIG. 1 is a perspective view of a metering module according to the invention;

FIG. 2 depicts the metering module of FIG. 1, without its cover;

FIG. 3 depicts the metering module of FIG. 1, viewed from the rear;

FIG. 4 is a schematic view depicting a cross section through the metering module of FIGS. 1 to 3;

FIG. 5 is a perspective view of a metering module according to a second embodiment of the invention;

FIG. 6 is a schematic view depicting the metering module of FIG. 5 in cross section;

FIG. 7 is a schematic view in cross section illustrating a variant embodiment of the invention.

### DESCRIPTION OF THE PREFERRED EMBODIMENTS

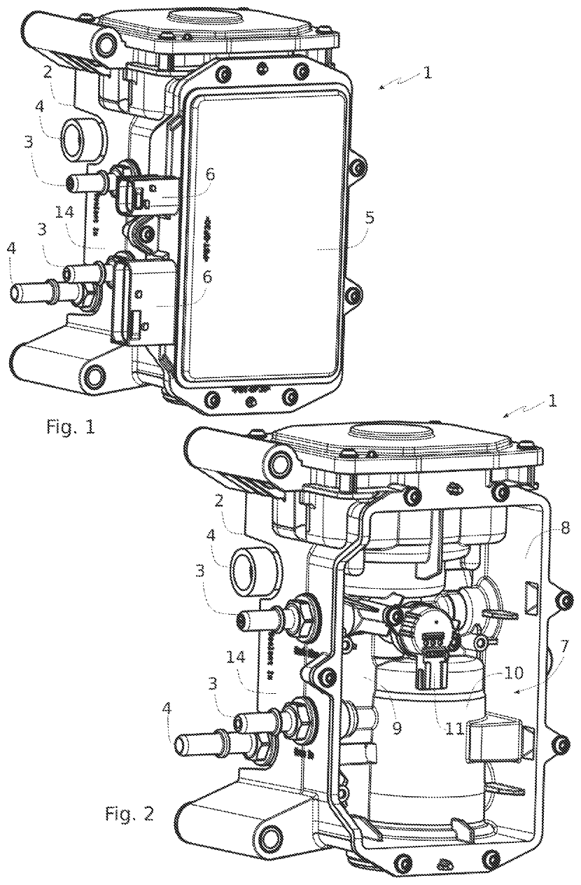

FIG. 1 depicts a module 1 for metering a reducing agent intended for a selective catalytic reduction post-treatment, for vehicles. This metering module 1 comprises a body 2 moulded as a single piece and forming the external case 14 of the module 1, and the internal architecture and pipes for circulating and treating the reducing agent. The body 2 in the present example is made by molding a polymer capable of resisting the reducing agent. The metering module 1 comprises hydraulic connectors 3 for the reducing agent. These hydraulic connectors 3 are intended to be connected to flexible pipes leading to other components of the post-treatment device. One of these hydraulic connectors 3 constitutes the reducing agent inlet intended to be connected to a reducing agent tank, and the other hydraulic connector 3 constitutes the reducing agent outlet intended to be connected to a reducing agent injector. Between the reducing agent inlet and outlet, the metering module 1 performs the functions that are conventional for this type of module, namely of controlling, filtering and pressurizing the reducing agent so that it can be injected into the catalytic device. The overall operation of such a reducing agent metering module is known and will not be described in greater detail here.

The metering module 1 additionally comprises hydraulic connectors 4 for the cooling circuit. These hydraulic connectors 4 intended to be connected to the vehicle cooling circuit so that the engine coolant acts as a hot fluid and circulates inside the module 1 in order to heat same, particularly when there is a need to thaw the reducing agent.

The metering module 1 comprises a cover 5 sealing an opening of the module 1 and bearing, on its internal face, a printed circuit supporting the electronic control and power components necessary for the operation of the metering module 1. The cover is equipped here with 2 connectors 6 connecting these electronics, carried on board the cover 5, to the other electronic devices of the vehicle and particularly to the engine control unit.

FIG. 2 depicts the metering module of FIG. 1 of which the cover 5 has been removed so as to show the space that is enclosed by the cover 5. This space is a compartment 5 rendered fluidtight by the closing of the cover 5. Aside from the cover 5, the compartment 7 is delimited by the body 2 itself and, more particularly, by a lateral wall 8 and by a fluidtight wall 9. The fluidtight wall 9 is opposite the cover 5 and the lateral wall 8 extends between the cover 5 and the fluidtight wall 9. The fluidtight wall 9 is at least partially coated with a heat transfer coating 10. An electric pump 16 for the reducing agent is also placed in the compartment 7.

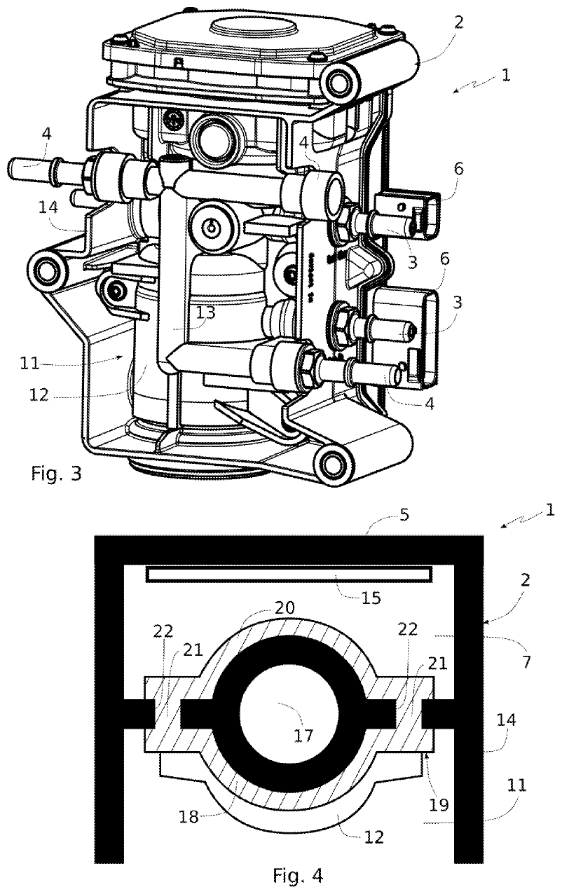

FIG. 3 depicts the metering module of FIGS. 1 and 2, viewed from the rear. This view shows another compartment 11 defined by the body 2 and situated opposite the compartment 7. The compartment 11, visible in FIG. 3, is not fitted with any cover or other element protecting or sealing it. Housed inside the compartment 11 are the heat transfer means contributing to the heating of the metering module 1. This means here consist of a heating shell 12 made from a material that is a metal or any other material having high thermal conductivity. The heating shell 12 has internal ducting 13, connected to the hydraulic connector 4 of the engine cooling circuit. The engine coolant, the temperature of which is high, therefore circulates in the ducting 13, rapidly heating the entirety of the heating shell 12, which itself heats the elements of the metering module 1 that it surrounds. The heating shell 12 is thus positioned around all the elements of the metering module 1 containing the reducing agent, so as to thaw the latter if necessary.

FIG. 4 is a schematic depiction of the metering module 1 in cross section, namely in a section on a plane that is horizontal with reference to the position of the module 1 in FIGS. 1 to 3. In this simplified view, the external case 14 of the body 2 can be seen in the lateral parts of the figure, and the cover 5 appears in the upper part of this FIG. 4.

In the present description and in the claims, the compartment equipped with the heating shell 12 is referred to as “first compartment” and the opposite compartment is referred to as “second compartment”.

Thus, in FIG. 6, the first compartment 11 contains only static mechanical components such as the heating shell 12 and its ducting, so that this first component 11 does not require any special protection against the external environment. The first compartment 11 is thus open, limiting the cost and mass of the metering module 1.

The second compartment 7 is itself a compartment that is fluidtight by the closing of the cover 5. This fluidtight second compartment 7 is put to use here to contain and protect electronic means belonging to the metering module 1. Thus, the electronics 15 are situated in this second compartment 7. The electrical components, such as the pump 16, are also situated in the second compartment 7 so as to be connected to the electronics 15.

The body 2 comprises, as set out hereinabove, internal ducting for the circulation of the reducing agent and the treatment thereof. In the simplified example of FIG. 4, a filter 17 is thus delimited by the body 2. This filter 17 comprises a reducing agent circulation zone of cylindrical shape in which the reducing agent passes through a filtering element. The filter 17 is depicted in the schematic view of FIG. 4 to illustrate a portion delimited by the body 2 and on which the heating shell 12 is to act as a matter of priority. In the first compartment 11, between the heating shell 12 and the portion of the body 2 that constitutes the filter 17, the module 1 comprises a first portion 18 of a heat transfer coating 19. This heat transfer coating 19 additionally comprises a second portion 20 partially surrounding the body 2 in the second compartment 7 around the filter 17. The heat transfer coating 19 additionally comprises thermal bridges 21 extending between these two portions 18, 20. These thermal bridges pass through orifices 22 in the fluidtight wall 9.

Because the second compartment 9 has to be fluidtight, the thermal bridges 21 pass through the orifices 22 in a fluidtight manner, namely by filling them.

In the cross section of FIG. 4, two thermal bridges 21 and their corresponding orifices 22 have been depicted. However, the heat transfer coating 19 may comprise as many thermal bridges 21 and associated orifices 22 as are necessary for a satisfactory distribution of the heat within the heat transfer coating 19, within the limits imposed by the mechanical strength required for the fluidtight wall 9.

The heat transfer coating 19 is produced in this instance as a single piece, by overmolding, onto the body 2, a thermoplastic elastomer polymer material having a thermal conductivity of at least 3 Watts per meter Kelvin and preferably of 5 Watts per meter Kelvin. Such a thermoplastic elastomer polymer is able to ensure the fluidtightness of the second compartment 7 by filling the orifices 22 completely and in a fluidtight manner. This material is additionally able, because of its high elasticity relating to its elastomer properties, to conform to the shape of the heating shell 12 and thus ensure optimum heat transfer without the need for an additional means such as a thermal lug. The heating shell 12 is preferably fixed to the fluidtight wall 9 and is clamped against the first portion 18 of the coating 19.

The manufacture of the metering module 1 is thus considerably simplified because, starting with a body 12 molded as a single piece and having orifices 22 in its fluidtight wall 9, the heat transfer coating 19 is then overmolded directly onto this body 2 in such a way as to cover the appropriate portions of the body 2, which is to say the portions for which heating is recommended, and finally that the heating shell 12 is mounted directly on the heat transfer coating 19.

The heat transfer coating 19 contributes to optimum distribution of the heat supplied by the heating shell 12, by diffusing this heat both through the first compartment 11 and through the second compartment 7 at the appropriate points. The thermal bridges 21 allow the heat to defuse without impairing the fluidtightness of the second compartment 7.

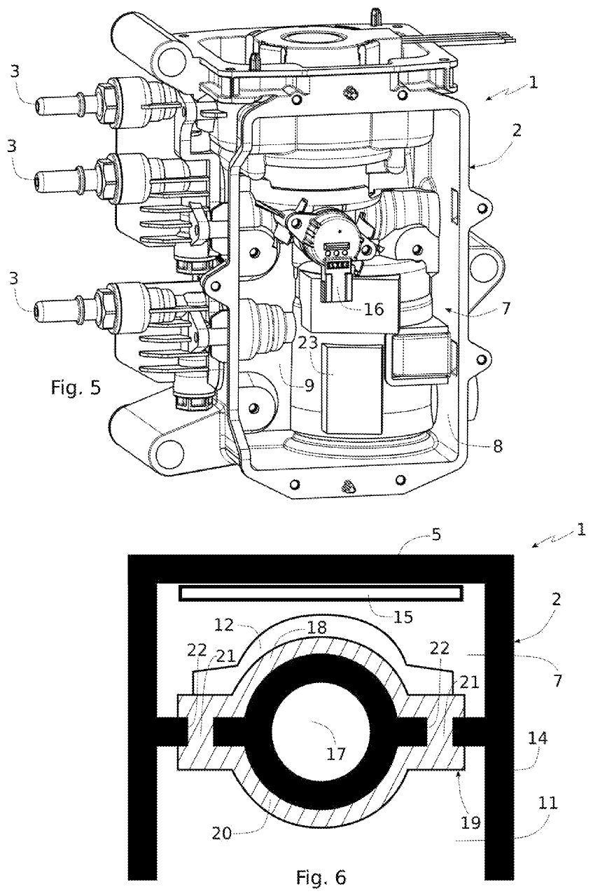

FIGS. 5 and 6 relate to a second embodiment of the metering module 1 according to the invention. In this second embodiment, the components that are common to the first embodiment are numbered using the same numbers.

In this second embodiment, the heating shell 12 is electrical and placed in the same compartment as the electronics 15.

FIG. 5 depicts the metering module 1 according to this second embodiment, viewed face-on and without its cover 5. Inside the compartment 7, in addition to the lateral wall 8, the fluidtight wall 9 and the pump 16, the module 1 comprises the heating shell 12.

The heating shell 12 has electrical heating means 23, such as a resistive electrical element, which, when the cover 5 is in place, are connected to the electronics 15.

In this second embodiment, because the heating shell 12 requires an electrical power supply, it has to be positioned on the side of the electronics 15 in order to be connected thereto, namely in this compartment 7. As stated previously, the compartment comprising the heating shell 12 is therefore referred to here as the first compartment 7.

FIG. 6 is a schematic depiction similar to that of FIG. 4 and concerned with this second embodiment. The heating shell 12 is therefore placed in the first compartment 7, namely in the fluidtight compartment containing the electronics 15. The heating shell 12 is connected to the electronics 15, as are the various other electrical devices.

On the opposite side to the first compartment 7, the second compartment 11 therefore does not have any electrical element and therefore does not require a cover or other protection against the external surroundings.

In this second embodiment, the heat transfer coating 19 is identical to that of the first embodiment, except that its first portion 18, which is positioned between the heating shell and the body 2, is therefore situated in the first compartment 7, while its second portion is situated in the second compartment 11. The heat transfer coating 19 is also identical to that of the first embodiment, having the same advantages.

In addition to the advantages described hereinabove and associated with reducing the cost and time involved in manufacturing the module 1, and the improvement to its thermal properties, this second embodiment demonstrates that the manufacture of the body 2 equipped with its heat transfer coating 19 can be standardized to produce both metering modules 1 that are equipped with a heating shell 12 connected to the engine cooling circuit, and modules 1 that are equipped with an electrical heating shell 12. The manufacturing method is thus further improved by mounting the suitable heating shell 12 in the appropriate compartment 7, 12 only at the end of the production line.

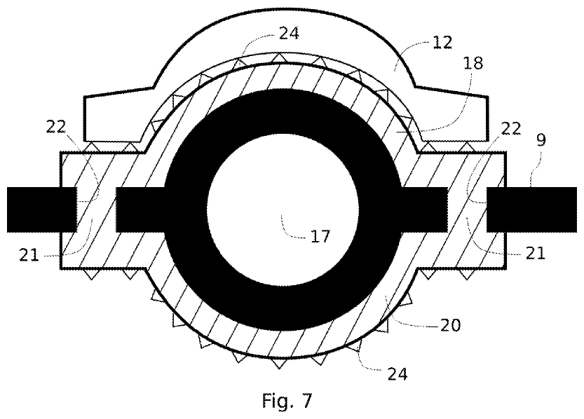

FIG. 7 illustrates an embodiment variant of the heat transfer coating 19 which is as applicable to the first embodiment as it is to the second embodiment.

This FIG. 7 is a partial schematic view similar to the views of FIGS. 4 and 6, depicting only the fluidtight wall 9, the filter 17 and the heating shell 12 and the heat transfer coating 19.

In this variant, the transfer coating 19 has ribs 24 its external surface, extending longitudinally, namely perpendicular to the plane of FIG. 7.

The section in FIG. 7, shows the profile of these ribs 24 which, in this example, is a triangular shape. These ribs 24, the height of which is of the order of a few millimeters, are produced as a single piece with the heat transfer coating 19. Because these ribs 24 are made of an elastomer material, they deform against the heating shell 12 when the latter is clamped, on assembly, against the heat transfer coating 19. The metering module 1 may comprise clamping means such as screws that do not pass all the way through the fluidtight wall 9, allowing the heating shell 12 to be clamped against the fluidtight wall 9. The ribs 24 thus allow tight clamping-together between the heating shell 12 and the heat transfer coating 19, encouraging heat transfer, this heat transfer remaining very good even if the heating shell 12 and the corresponding portion of the body 2 which is coated with the transfer coating 19 have complex shapes.

In the opposite compartment, the ribs 24 improve the heat transfer to the environment of the heat transfer coating 19.

Variant embodiments of the metering module may be envisioned without departing from the scope of the invention. In particular, the heat transfer coating 19 may surround any other part of the module other than the one described here, which might require effective heating for the reducing agent.

1. A module (1) for metering a reducing agent intended for a vehicle selective catalytic reduction post-treatment, this module comprising:
a body (2) in which the reducing agent circulates, this body (2) comprising a first compartment (7; 11) and a second compartment (7; 11) which are separated by a fluidtight partition (9);
a heating shell (12) partially surrounding the body (2) in the first compartment;
wherein, the body (2) comprising a heat transfer coating (19) made from a thermoplastic elastomer material having a thermal conductivity of at least 3 Watts per meter Kelvin, this heat transfer coating (19) comprising:
a first portion (18) positioned between the heating shell (12) and the body (2);
a second portion (20) partially surrounding the body (2) in the second compartment;
thermal bridges (21) passing through the fluidtight partition (9) and connecting the first portion (18) to the second portion (20).

2. The metering module as claimed in claim 1, wherein the fluidtight partition (9) comprises open-ended orifices (22) which are filled by the thermal bridges (21).

3. The metering module as claimed in claim 1, wherein the heat transfer coating (19) is made as a single piece overmolded on the body (2).

4. The metering module as claimed in claim 1, wherein the body (2) is made as a single piece.

5. The metering module as claimed in claim 1, wherein the heating shell (12) is in direct contact with the heat transfer coating (10).

6. The metering module as claimed in claim 5, wherein the heating shell (12) is fixed to the fluidtight partition (9) and is clamped against the heat transfer coating (19).

7. The metering module as claimed in claim 1, wherein the heat transfer coating (19) has ribs (24) on its an external surface.

8. The metering module as claimed in claim 1, wherein the the first compartment (7) of the body (2) comprises electronic means (15) and wherein the heating shell (12) is equipped with electrical heating elements (23) connected to the electronic means (15).

9. The metering module as claimed in claim 1, wherein the heating shall (12) is equipped with circulation pipes (13) for a hot fluid, and wherein the second compartment (7) of the body (2) comprises electronic means (15).

10. A method for manufacturing a metering module (1) as claimed in claim 1, further comprising the following steps:
molding as a single piece the module body (2) having a partition (9) delimiting a first and a second compartment, this partition (9) comprising through-orifices (22) between the first compartment and the second compartment;
overmolding onto the body (2) a heat transfer coating (10) of one piece in a thermoplastic elastomer material so that this coating (10) fills the orifices (22) of the fluidtight wall (9) and at least partially surrounds the body (2) in the first compartment and in the second compartment.

11. The metering module as claimed in claim 2, wherein the heat transfer coating (19) is made as a single piece overmolded on the body (2).

12. The metering module as claimed in claim 2, wherein the body (2) is made as a single piece.

13. The metering module as claimed in claim 3, wherein the body (2) is made as a single piece.

14. The metering module as claimed in claim 2, wherein the heating shell (12) is in direct contact with the heat transfer coating (10).

15. The metering module as claimed in claim 3, wherein the heating shell (12) is in direct contact with the heat transfer coating (10).

16. The metering module as claimed in claim 4, wherein the heating shell (12) is in direct contact with the heat transfer coating (10).

17. The metering module as claimed in claim 2, wherein the heat transfer coating (19) has ribs (24) on an external surface.

18. The metering module as claimed in claim 3, wherein the heat transfer coating (19) has ribs (24) on an external surface.

19. The metering module as claimed in claim 4, wherein the heat transfer coating (19) has ribs (24) on an external surface.

20. The metering module as claimed in claim 5, wherein the heat transfer coating (19) has ribs (24) on an external surface.
